(19) United States
(12) Patent Application Publication
(10) Pub. No.: US 2003/0077032 A1
(43) Pub. Date: Apr. 24, 2003

(54) Long distance optical transmission system for high dynamic range signals

(76) Inventor: Irl N. Duling, Lancaster, PA (US)

Correspondence Address: PILLSBURY WINTHROP, LLP, P.O. BOX 10500, MCLEAN, VA, 22102, US

(21) Appl. No.: 10/267,030

(22) Filed: Oct. 9, 2002

Related U.S. Application Data
(60) Provisional application No. 60/327,777, filed on Oct. 10, 2001.

(51) Int. Cl. G02B 6/28; G02B 6/26; H04B 10/12; H01S 3/00

(52) U.S. Cl. 385/24; 359/173; 359/334; 385/27

(57) ABSTRACT

An optical communication system includes an optical transmission line with a pump laser port, a transmitter in communication with a multilevel coded electrical input signal and in communication with the optical transmission line, and a pump laser optically connected to the pump laser port. In the optical communication system, the optical transmission line and the pump laser are adapted to act in cooperation to amplify an optical signal traveling through the optical transmission line over at least a portion of a length of the transmission line.

This Application is based on Provisional Application No. 60/327,777 filed Oct. 10, 2001, the entire contents of which is hereby incorporated by reference.

### BACKGROUND

1. Field of Invention

The invention relates to optical transmission systems, and more particularly to a long distance optical transmission system for transmitting signals that have a high dynamic range.

2. Discussion of Related Art

Demand for optical communication systems is growing with the growing demand for faster broadband and more reliable networks. Wavelength division multiplexing (WDM) is one technique used to increase the capacity of optical communication systems. Such optical communication systems include, but are not limited to, telecommunication systems, cable television systems (CATV), and local area networks (LANs). An introduction to the field of Optical Communications can be found in “Optical Communication Systems” by Gowar, ed. Prentice Hall, NY, 1993.

WDM optical communication systems carry multiple optical signal channels, each channel being assigned a different wavelength. Optical signal channels are generated, multiplexed to form an optical signal comprised of the individual optical signal channels, and transmitted over a single waveguide such as an optical fiber. The optical signal is subsequently demultiplexed such that each channel corresponding to a wavelength is individually routed to a designated receiver.

In wavelength division multiplexing, the transmitted wavelengths are locked to one of the International Telephone Union (ITU) standard wavelengths, called the ITU grid, to meet cross-talk specification and reliability in operation over time. Technologies such as Distributed Feedback Lasers (DFB) are used to provide a source at a desired wavelength for the ITU grid.

In a digital transmission system, signals which are constituted of a series of ones and zeros are sent from a transmitter to a receiver. The receiver must be able to distinguish ones from zeros. This requirement puts certain limitations on the signal to noise ratio of the signal at the receiver end. If the transmitted signal consists of multilevel coded data such as duo-binary modulated, quadrature amplitude modulated (QAM), or analog modulated, then the requirement on the dynamic range at the receiver is increased.

Quadrature amplitude modulation is a modulation scheme in which data is encoded onto a radio frequency (RF) carrier in both amplitude and phase. Multiple values of modulation can be used on each, resulting in a multilevel coding. Because each symbol represents one value out of many, the data rate can exceed the symbol rate by many times. Since the symbol rate is what determines the data signal bandwidth, QAM enables data transmission at many times the rate of standard on-off-keyed modulation (OOK).

The dynamic range is defined as the ratio of the maximum signal to noise. The dynamic range of an encoded analog signal is in many cases required to be greater than 60 dB. The need to preserve a certain minimum signal-to-noise ratio at the receiver input represents one of the main design criteria of an optical communication system. A value of 12 dB may be adequate for a standard OOK signal, while 20 to 30 dB may be adequate in a QAM digital channel, but values higher than 60 dB may be required in analog transmissions such as during the transmission of audio and video signals.

When optical fibers are used as the transmission system, there is inherent loss in the optical fiber which in a good quality optical fiber is generally about 0.2 dB/km. This means that when a signal propagates 30 km, the signal strength decreases by a factor of 4. Therefore, in order to propagate signals farther than the loss in the optical fiber would allow, reamplification of the signal is necessary. Erbium doped fiber amplifiers (EDFA) have been used for this purpose. However, erbium doped amplifiers are discrete elements in that they are positionally localized. An EDFA typically includes a coil of erbium-doped specialty fiber at discrete locations along the transmission path. Such coils of erbium-doped fiber do not serve the purpose of transmitting the signal closer to its destination. Each stage of reamplification introduces noise inversely proportional to the strength of the signal reaching the amplifier (n α1/s₁, where n is the noise and s, is the signal reaching amplifier i). Therefore, if the signal is weak the noise becomes important.

For economic reasons, it is desirable to insert as few optical amplifiers as possible. The trade-off is against the received signal to noise ratio. One possibility to combat the loss in power of the signal in the optical fiber is to increase the power of the signal at the launch, i.e. at the entrance of the optical fiber. However, the signal cannot be made arbitrarily large at the launch (entrance to the optical fiber at the transmitter) without creating distortion in the propagating signal due to nonlinear effects induced in the optical fiber when working at high power.

To some extent this nonlinear distortion is determined by the total power in the fiber, not just the power in a single channel (i.e. wavelength), so as WDM channels are added the power in each single channel must be reduced causing an additional trade-off for received signal to noise ratio.

To date multi-level coded signals have only been able to be transmitted a couple of hundred kilometers before they must be electronically regenerated.

Therefore, it is desirable to overcome these and other limitations thus allowing overall improved performance and reduced cost of the transmission system.

### SUMMARY

One aspect of the present invention is to provide an optical communication system, including an optical transmission line comprising a pump laser port, a transmitter in communication with a multilevel coded electrical input signal and in communication with the optical transmission line, and a pump laser optically connected to the pump laser port. In the optical communication system, the optical transmission line and the pump laser are adapted to act in cooperation to amplify an optical signal traveling through the optical transmission line over at least a portion of a length of the transmission line.

In one embodiment, the pump laser causes amplification by Raman scattering from a material of the transmission line. In another embodiment the pump laser causes amplification by Brillouin scattering from a material of the transmission line. In yet another embodiment, the transmission line comprises erbium doping along the transmission line.

In one embodiment, the optical transmission line and the pump laser are adapted to act in cooperation to amplify the optical signal traveling through the optical transmission line over substantially an entire length of the transmission line.

In different embodiments of the optical communication system, the multilevel coded signal may be selected from a quadrature amplitude modulated signal, a duo-binary modulated signal, or an analog modulated signal.

In one embodiment, the optical communication system may further comprise a second transmitter in communication with a second multilevel coded electrical input signal and in communication with the optical transmission line and an optical multiplexer arranged between the optical transmission line and the first mentioned and the second transmitters. In this embodiment, the optical multiplexer is structured to form a wavelength division multiplexed optical signal from optical signals from the first mentioned and the second transmitters.

In an alternative embodiment, the optical communication system may comprise an electrical multiplexer in communication with a plurality of electrical signals and in communication with the transmitter. In this embodiment, the electrical multiplexer combines the plurality of electrical signals into a single multiplexed electrical signal and the transmitter comprises a modulator operative in response to the single multiplexed electrical signal.

Another aspect of the present invention is to provide a method of transmitting information, the method comprising forming a multilevel coded signal, converting the multilevel coded signal to an optical signal, transmitting the optical signal between a first location and a second location, and amplifying the optical signal along at least a portion of a transmission path between the first location and the second location.

In one embodiment the method of transmitting information may further comprise multiplexing the multilevel coded signal in the electrical domain to provide a subcarrier modulated signal for converting the multilevel coded signal.

In an alternative embodiment, the method of transmitting information may comprise forming a second multilevel coded signal and multiplexing the first mentioned multilevel coded signal and the second multilevel coded signal to form a wavelength division multiplexed optical signal.

### BRIEF DESCRIPTION OF THE DRAWINGS

These and other objects and advantages of the invention will become more apparent and more readily appreciated from the following detailed description of the presently preferred exemplary embodiments of the invention, taken in conjunction with the accompanying drawings, of which:

FIG. 1 is a schematic representation of an optical transmission system according to one embodiment of the present invention;

FIGS. 2a shows a configuration for coupling pump radiation into the transmission line wherein the optical pump propagates in a same direction as the direction of the propagation of the signal;

FIG. 2b shows a configuration for coupling pump radiation into the transmission line wherein the optical pump propagates in a direction opposite to the direction of propagation of the signal;

FIG. 3a shows a configuration for amplifying the optical signal similar to FIG. 2a but including an erbium doped fiber amplifier placed downstream as at least a portion of the transmission line; and

FIG. 3b shows a configuration for amplifying the optical signal similar to FIG. 2b but including an erbium doped fiber amplifier placed upstream as at least a portion of the transmission line.

### DETAILED DESCRIPTION OF THE PREFERRED EMBODIMENTS

In the following description, in order to facilitate a thorough understanding of the invention and for purposes of explanation and not limitation, specific details are set forth such as particular optical and electrical circuits, circuit components, techniques, etc. However, the invention may be practiced in other embodiments that depart from these specific details. The terms optical and light are used in a broad sense in this description to include both visible and non-visible regions of the electromagnetic spectrum. Currently, infrared light is used extensively in transmitting signals in optical communication systems. Infrared light is included within the broad meaning of the term light as used herein.

In one embodiment of the invention, modulated electrical signals are first produced by modulating RF subcarriers. The signal may be modulated using various modulation schemes such as quadrature amplitude modulation, duo-binary, or analog modulation. The signals may then be used to modulate optical signals or may be multiplexed with one or more signals in the electrical domain prior to using it for subcarrier modulation of an optical signal.

The instant inventors have obtained strong gains in signal quality for subcarrier modulated optical signals transmitted over a distributed amplifying transmission line according to this invention as compared to prior art lumped amplification.

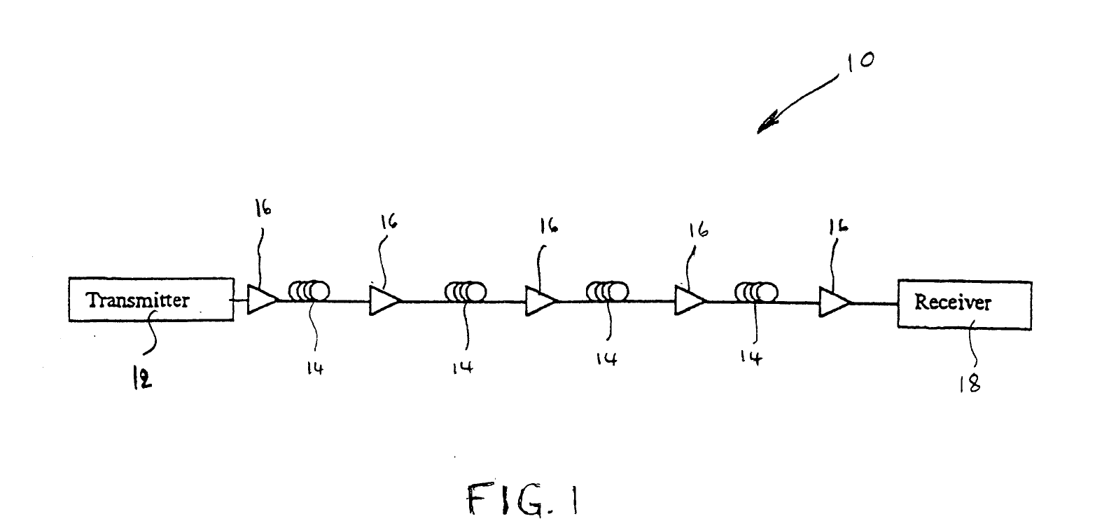

FIG. 1 shows a schematic representation of an optical communication system that has a distributed amplification system according to one embodiment of the present invention. In this embodiment, the optical communication system 10 includes a transmitter 12, fiber spools 14 which represent a span of the transmission line, amplifier pump modules 16, and a receiver 18. The transmitter 10 converts an electrical signal into an optical signal and transmits it into an optical transmission system. The optical signal can be a multilevel signal, for example, a quadrature amplitude modulated, duo-binary or analog modulated signal.

The fiber spools 14 represent the transmission fiber in the optical communications system which typically have a linear loss and a nonlinear refractive index. The amplifier pump modules 16 comprise pump lasers selected for the type of distributed amplifier used. This distributed amplification can be accomplished using various techniques including distributed Er::fiber amplifiers, Raman amplification in the transmission fiber, periodically tuned Brillouin amplifiers, or any other distributed amplifier.

For example, if a Raman amplifier is used, the pump lasers would be selected from high power laser pump sources emitting at a frequency higher than that of the optical signal by the appropriate Raman shift. This is because in the Stimulated Raman Scattering (SRS) effect, photons, which are inelastically scattered due to interaction with the dipole moment of core material in the optical fiber, are inelastically scattered with less energy than incident photons (observed as spectral signals called Stokes lines with longer wavelengths than the wavelength of the incident photons). The difference in energy between the scattered photons and the incident photons is called the Raman shift. Thus, the need to use pump lasers emitting at a higher frequency than the optical signal to account for the energy difference corresponding to the Raman shift. The anti-Stokes lines (observed at shorter wavelengths than the wavelength of the incident photons) in Raman spectral signals are much less intense than the Stokes lines by an order of 100 to 1000. Therefore, the anti-Stoke signal suffers enhanced absorption in the corresponding stimulated Raman process.

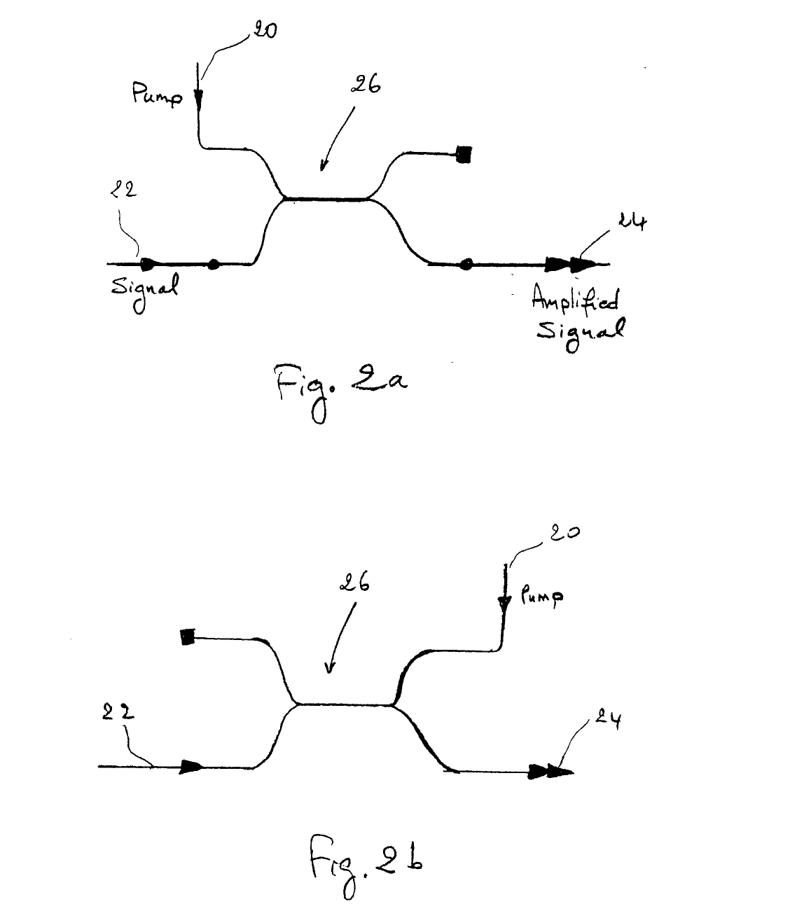

For example, in one embodiment, the pump laser is constructed and arranged to propagate in the direction of the propagation of the signal as shown schematically in FIG. 2a. In another embodiment, the pump laser is constructed and arranged to propagate in the opposite direction relative to the propagation of the signal as shown schematically in FIG. 2b. FIG. 2a and FIG. 2b show, the pump laser 20, the signal 22, and the resultant amplified signal 24. In FIG. 2a, the pump laser is shown traveling in the same direction as the signal, whereas in FIG. 2b, the pump laser is shown traveling in the opposite direction. In both FIG. 2a and FIG. 2b arrangements the pump radiation is shown coupled into each fiber amplifier by using a 2×2 coupler 26, however other means may be used to achieve the coupling between the pump and the signal.

When the pump energy travels in the opposite direction, it can provide a beneficial power averaging. In this case, the gain is averaged over possible variations in the pump amplitude. This is because the power of the laser pump being convoluted with the optical power of the signal, a temporal variation in the pump power would not copropagate with the signal transferring its temporal variation to the signal, but the signal is amplified by many temporal portions of the pump. Thus the gain is maintained relatively constant, i.e. averaged, along the path of transmission.

As previously mentioned, the pump light is at a higher frequency than the signal by the Raman shift. In the case of silica, the Raman shift is approximately 400 wavenumbers. The Raman amplifier, used in either forward or backward configuration as shown respectively in FIG. 2a and FIG. 2b, can produce some 10-15 dB of gain per watt of pump power over a bandwidth of some 50 nm (6000 GHz).

If a Stimulated Brillouin Scattering (SBS) amplification is used, the amplification occurs in the backward direction (light is mostly reflected backward) due to the inelastic interaction of incident photons with the vibrational modes of the lattice in the core material of the optical fiber. Therefore, the arrangement shown in FIG. 2b would be more suitable for Brillouin amplification in order to amplify the signal in the forward direction. A Brillouin fiber amplifier of the type shown in FIG. 2b can provide some 10-20 dB of fiber-to-fiber gain with a pump power of a few mW. The very narrow (30 MHz) bandwidth of such a Brillouin amplification greatly restricts its application. However, this can also be used as an advantage, for example in selective amplification of a particular wavelength channel. Or the pump frequency can be varied on a time scale shorter than the fiber length to provide gain at a variety of frequencies, and so in an averaged manner, over a broad bandwidth.

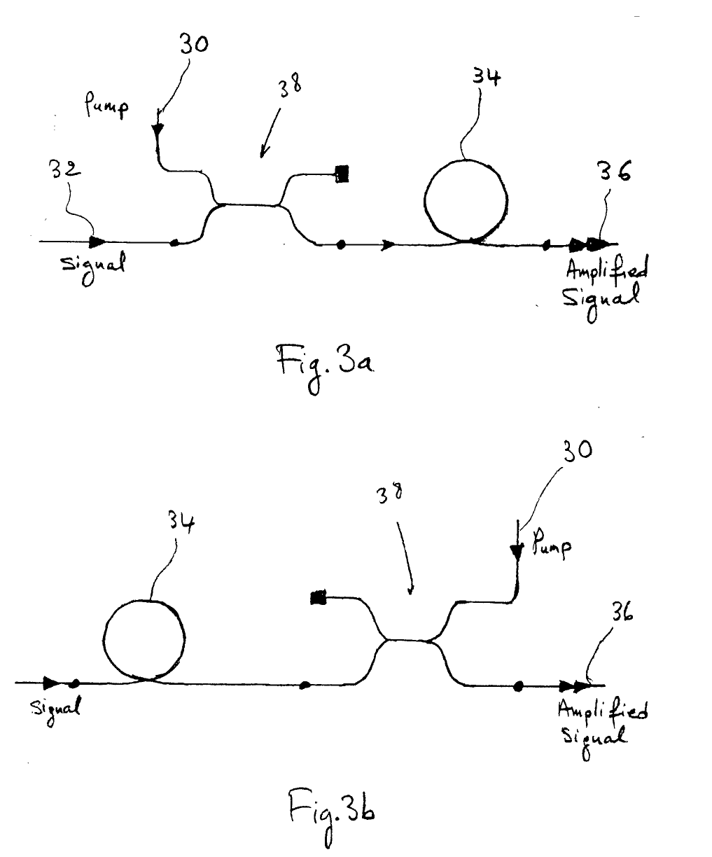

If, on the other hand, a distributed erbium doped fiber amplifier is used, then the transmission fiber 14 will also have a small amount of erbium doped into the fiber and the pump modules will comprise lasers emitting at 1480 nm or at 980 nm, or other suitable wavelengths for pumping the erbium doped in the fiber. In the alternative, fiber that is doped with other active elements in addition to or instead of erbium may be selected to provide gain at the signal wavelength. The amplifier pump modules can also incorporate a lumped amplifier. For example, many lumps could be used in the optical transmission system to achieve amplification of the optical signal. However, this may be more expensive. For example, the lumped amplifier could be an erbium doped fiber amplifier. FIG. 3a shows an optical amplifier configuration using an erbium doped fiber amplifier and FIG. 3b shows an optical amplifier configuration using an erbium doped fiber amplifier with contra-directional pumping. Similarly to the arrangements of FIGS. 2a and 2b, the pump radiation 30 is shown in FIGS. 3a and 3b coupled into each fiber amplifier by a using a 2×2 coupler 38, however other means may be used to achieve the coupling between the pump and the signal. In FIG. 3a, the erbium doped fiber amplifier 34 is shown placed downstream of coupler 38, whereas in FIG. 3b the erbium doped amplifier 34 is shown upstream of the coupler 38. The amplified signal 36 is shown in both figures by a double arrow.

Erbium doped fiber amplifiers can provide gain over a linewidth of about 40 nm centered on 1550 nm. The gain is a function of doping concentration and the length of the fiber used and it depends also on the power and the spectral distribution of the pump radiation. According to the energy level diagram of Er³⁺ in glass (erbium doped fiber) the pump may either lie around 1480 nm or 980 nm. Pumping at around 1480 nm provides increased power efficiency over 980 nm. A gain of up to 20 dB can be obtained in 10-20 m of fiber doped with up to 100 ppm of erbium, using about 100 mW of pump power.

The use of distributed amplification allows one to substantially reduce degradation of the signals compared to waiting until the signal-to-noise ratio decreases and then amplifying noise along with the signal in the optical fiber. The signal is thus kept at a comfortable level to allow amplification while minimizing introduction of noise. Moreover, since the signal is amplified along substantial portions, if not all, of the transmission fiber, less power can be launched at the transmitter thus reducing the undesirable linear effects that may occur otherwise.

Though the transmission system has been described in connection to its application in communication networks and systems operating in the 1550 nm low loss transmission window of the optical fiber, the transmission system technique may also be applicable to a wide range of wavelengths.

While the invention has been described in connection with particular embodiments, it is to be understood that the invention is not limited to only the embodiments described, but on the contrary it is intended to cover all modifications and arrangements included within the spirit and scope of the invention as defined by the claims, which follow.

What is claimed is:

1. An optical communication system, comprising:
an optical transmission line comprising a pump laser port;
a transmitter in communication with a multilevel coded electrical input signal and in communication with said optical transmission line; and
a pump laser optically connected to said pump laser port,
wherein said optical transmission line and said pump laser are adapted to act in cooperation to amplify an optical signal traveling through said optical transmission line over at least a portion of a length of said transmission line.

2. An optical communication system as recited in claim 1, wherein said pump laser causes amplification by Raman scattering from a material of said transmission line.

3. An optical communication system as recited in claim 1, wherein said pump laser travels in an opposite direction to a direction of propagation of said optical signal so that a gain in amplification is averaged over variations in amplitude of said pump laser.

4. An optical communication system as recited in claim 1, wherein said pump laser causes amplification by Brillouin scattering from a material of said transmission line.

5. An optical communication system as recited in claim 1, wherein said transmission line comprises a distribution of erbium along the transmission line.

6. An optical communication system as recited in claim 1, further comprising:
a second transmitter in communication with a second multilevel coded electrical input signal and in communication with said optical transmission line; and
an optical multiplexer arranged between said optical transmission line and the first mentioned and said second transmitters,
wherein said optical multiplexer is structured to form a wavelength division multiplexed optical signal from optical signals from the first mentioned and said second transmitters.

7. An optical communication system as recited in claim 1, wherein said multilevel coded signal is a quadrature amplitude modulated signal.

8. An optical communication system as recited in claim 1, wherein said multilevel coded signal is a duo-binary modulated signal.

9. An optical communication system as recited in claim 1, wherein said multilevel coded signal is an analog modulated signal.

10. An optical communication system as recited in claim 1, further comprising an electrical multiplexer in communication with a plurality of electrical signals and in communication with said transmitter,
wherein said electrical multiplexer combines said plurality of electrical signals into a single multiplexed electrical signal and said transmitter comprises a modulator operative in response to said single multiplexed electrical signal.

11. An optical communication system as recited in claim 1, wherein said optical transmission line and said pump laser are adapted to act in cooperation to amplify the optical signal traveling through the optical transmission line over substantially an entire length of said transmission line.

12. A method of transmitting information, comprising:
forming a multilevel coded signal in an electrical domain;
converting said multilevel coded signal to an optical signal;
transmitting said optical signal between a first location and a second location; and
amplifying said optical signal along at least a portion of a transmission path between said first location and said second location.

13. A method of transmitting information as recited in claim 12, wherein said optical signal is a quadrature amplitude modulated signal.

14. A method of transmitting information as recited in claim 12, wherein said optical signal is a duo-binary modulated signal.

15. A method of transmitting information as recited in claim 12, wherein said optical signal is an analog modulated signal.

16. A method of transmitting information as recited in claim 12, further comprising:
multiplexing said multilevel coded signal in the electrical domain to provide a subcarrier modulated signal for converting said multilevel coded signal.

17. A method of transmitting information as recited in claim 12, further comprising:
forming a second multilevel coded signal;
converting said second multilevel coded signal to a second optical signal; and
multiplexing the first mentioned optical signal and said second optical signal to form a wavelength division multiplexed optical signal prior to said transmitting said optical signal between a first location and a second location.

18. A method of transmitting information as recited in claim 12, further comprising:
forming a plurality of electrical signals;
multiplexing electrically said electrical signals to form a single multiplexed electrical signal; and
modulating said multilevel coded signal with said multiplexed electrical signal.

19. A method of transmitting information as recited in claim 12, wherein said amplifying comprises amplifying using stimulated Raman scattering.

20. A method of transmitting information as recited in claim 12, wherein said amplifying comprises amplifying using stimulated Brillouin scattering.

21. A method of transmitting information as recited in claim 12, wherein said amplifying comprises amplifying using distributed erbium doped into said portion of the transmission path.

22. A method of transmitting information as recited in claim 12, wherein said amplifying comprises amplifying along substantially an entire length of said transmission path.
